(19) United States
(12) Patent Application Publication
(10) Pub. No.: US 2023/0402635 A1
(43) Pub. Date: Dec. 14, 2023

(54) NOVEL ELECTROCHEMICAL CELLS, STACKS, MODULES AND SYSTEMS

(71) Applicant: Joseph Peter MACEDA, New York, NY (US)

(72) Inventor: Joseph Peter MACEDA, New York, NY (US)

(21) Appl. No.: 17/760,203

(22) PCT Filed: Feb. 12, 2021
(86) PCT No.: PCT/US2021/010003

§ 371 Date: Aug. 5, 2022

Related U.S. Application Data
(60) Provisional application No. 62/975,231, filed on Feb. 12, 2020.

(51) Int. Cl. H01M 8/0656; H01M 8/0612; C25B 15/08; C25B 1/02; C25B 15/021

(52) U.S. Cl. CPC H01M 8/0656; H01M 8/0618; C25B 15/08; C25B 1/02; C25B 15/021

(57) ABSTRACT

This present invention describes novel cells, stacks modules and systems that serve as i) liquid-phase electrochemical reformers (ECR) for capturing carbonaceous species in ionically conductive liquid electrolytes and producing hydrogen, ii) carbon capture and reuse (CCR) cells, that use hydrogen, and/or heat and/or electricity to decarbonize ionically conductive electrolyte evolving oxygen at one electrode and hydrocarbons or oxygenated hydrocarbons at the other, iii) fuel cells, iv) integrated ECR/CCR stacks, modules and systems, and, v) integrated ECR/Fuel Cell/CCR modules and systems.

### CROSS-REFERENCE TO RELATED APPLICATIONS

This application claims the benefit of the filing dates of U.S. Provisional Patent Applications No. 62/975,231 filed Feb. 12, 2020, the disclosures of which are incorporated herein by reference.

### FIELD OF INVENTION

This present invention relates to the field of planar, electrochemical cells. These cells can be electrically and/or thermally driven and be used for i) liquid-phase, electrochemical reforming (ECR), ii) liquid-phase, carbon capture and reuse (CCR), and, iii) fuel cells, with either solid of liquid electrolyte.

### BACKGROUND OF THE INVENTION

In planar electrochemical cells, there are potential changes when the cells are hot or cold when the thermal gradients are formed between the electrode and the electrolyte. This condition occurs due to the entropy of the anodic and cathodic reactions on the electrodes, the heat capacity of the reactants and the products, thermo-conductivity differentials of the parts of the system and the combination thereof. This invention describes a cell and stack design that can be configured into a wide range of electrochemical modules and systems that can be thermally or electrically driven and carefully manage these thermal disparities to increase efficiency, increase lifetime, prevent electrode poisoning, prevent unwanted side reactions, and increase uniformity in the cell and stack. This invention will also allow for fast start up and load following using electrical input and the ability to shift between electrical and thermal inputs, depending on which would be the optimal driving force based on local conditions and demand.

These cells can be made into reaction-specific modules that can then be integrated into closely coupled integrated systems that enhance overall performance and can be integrated further, thermally and electrically, with external input suppliers and product offtakers. Table 1 below shows the three initial electrochemical processes of interest.

TABLE 1
Electrochemical Reactions

| | Anodic Reaction | Cathodic Reaction | Net Reaction |
|---|---|---|---|
| Alkaline | CH₃OH + 8OH [symbol] => CO3═ + 6e− | 6H₂O = 6e− => 3H₂ = 6OH [symbol] | CH₃OH = 2OH— => CO₃ [symbol] + 3H₂ |
| Electrochemical | | | |
| Reformer | | | |
| Alkaline | 28OH [symbol] => 14H₂O + 7O₂ + 28e− | 4CO₃═ = 24H₂O + 28 [symbol] − => | 4CO [symbol] + 10H₂O + 28e− => |
| Decarbonizer | | 2C₂H [symbol] + 36OH [symbol] | 2C₂H₈ + 80H [symbol] + 7O₂ |
| Alkaline Fuel | H₂ + 2OH [symbol] => 2H₂O + 2e | 1/2 O2 + 2H [symbol] + 2e− => H₂O | H2 + 1/2O₂ => H₂O |
| cell | | | |

[symbol]

indicates data missing or illegible when filed

For example, a first embodiment of the present invention, an example of which is shown in the first row of Table 1, is the liquid-phase Grimes' Processes known as Electrochemical Reforming elements that are disclosed in the following Grimes' patents, U.S. Pat. Nos. 8,419,922, and 8,318,130. Other embodiments of this process are disclosed in the family of Reichman WO Patent Applications descended from U.S. Pat. No. 6,994,839. In these processes, a carbonaceous fuel (oxidizable Reactant A) is mixed with water (reducible Reactant B) and an ionically conductive electrolyte (that can be acidic, basic or a buffer solution) that is fed into a cell that uses electricity, and/or heat to help drive the further oxidation of Reactant A to carbonate, while reducing the water, thereby releasing gaseous hydrogen and carbonize liquid electrolyte.

A second embodiment of the present invention, an example of which is shown in the second row of Table 1, is the liquid-phase Grimes' Processes known as Carbon Capture and Reuse, elements of which have been disclosed in U.S. Pat. No. 8,828,216. In this reaction, a carbonized bicarbonate electrolyte is fed into a cell and either electricity or hydrogen is used to reduce the electrolyte to hydroxide, evolving oxygen at one electrode and hydrocarbons or oxygenated hydrocarbons at the other.

An example of a third embodiment of this invention is shown in row three of Table 1 where an alkaline fuel cell combines the reactants to produce electricity. These cells are well understood but the ability to precisely control heat flows in and out of the individual electrodes is unique to this approach. These fuel cells can be alkaline, neutral or acidic, with either solid or liquid electrolytes and be fed with either gaseous or liquid reactants.

This invention would also improve the performance of cells and stacks operating in the reverse reactions of electrolysis.

All of these processes could have similar structures integrated prior to the reaction chambers where premixing, mixing or separation can be done. These calls can also be designed for either low-pressure or high pressure operation. Since the gases evolve at a small pressure above the liquid electrolyte pressure, this would eliminate the need for external gas-phase compression of either hydrogen, oxygen or other products and by-products.

### SUMMARY OF THE INVENTION

The core of this invention is a cell design that integrates thermal management capabilities at each electrode so that the ideal, uniform operating conditions can be maintained through the cells operating cycle. These cells are also modular in that they can hold a variety of different electrodes and electrolytes and be configured to make a wide range of products and co-products. These cells can then be stacked into discrete modules that can be configured in a variety of configurations into stand-alone units with the either half or full cell capabilities. In one embodiment, a plurality of single electrode ECR cells could be configured to provide hydrogen with the carbonized electrolyte being removed for storage or transport for subsequent decarbonization. In another embodiment, the ECR cell could be integrated with a plurality of CCR cells with the carbonized electrolyte being immediately decarbonized and the regenerated electrolyte fed directly back into the ECR.

A second embodiment integrates CCR cells to produce the same hydrocarbon, or oxygenated hydrocarbon, as the system's primary energy source and this CCR output would be fed back into the system input to reduce the amount of imported energy required, while the oxygen would be exported.

In a third embodiment, the CCR's decarbonized electrolyte would be fed back into the ECR while the hydrocarbon or oxygenated hydrocarbon would be exported. In a fourth embodiment, an ECR could produce hydrogen, while a CCR could produce oxygen, each of which could be fed to the appropriate electrode of a fuel cell to produce electricity, while the carbonized electrolyte regenerated in the CCR is fed back into the ECR for reuse, while the hydrocarbon, or oxygenated hydrocarbon, produced is fed back into the ECR input to improve overall system efficiency.

A fifth embodiment of this inventions would be similar to the fourth embodiment but the oxygenated hydrocarbon produced could be a reactant that could be stored, transported or used immediately in a separate fuel cell, i.e. formate, formic acid or methanol.

These cells can be arrayed in sub-stacks by function, interleaved to minimize reactant travel distances, geographically separated by significant distances or tightly integrated spatially to minimize thermal losses. In all cases thermal integration will be maximized.

These embodiments are illustrative and not meant to limit the scope of the invention.

### BRIEF DESCRIPTION OF THE DRAWINGS

FIG. 1 shows the Ground State of carbon is not carbon dioxide (CO₂) but carbonate (CO₃). It also shows that a significant amount of recoverable energy is still available from CO₂.

FIG. 2 displays the energy content of various carbon based fuels and feedstocks on both the Carnot scale (left) and the Gibbs scale (right).

FIG. 3 shows a Grimes Free Energy process that is driven by both thermal energy and electrical energy. The necessary inputs are an oxidizable reactant A, a Reducible Reactant B, an ionically conductive electrolyte and some form of work. Under proper conditions these will produce the Desired Synthesis Product C and a By-Product D.

FIG. 4 is a Table showing a range of oxidizable reactants, reducible reactants, ionically conductive electrolytes, work, power and delta G inputs, electron transfer materials, desired synthesis products and by-products that can be processed by the redox reactor of FIG. 3. The lower portion of the table shows examples of how methane (CH₄) can be synthesized from an input of methanol (CH₃OH) and that the reverse synthesis of methanol can be synthesized from an input of methane.

FIG. 5 shows how the ECR integrates features from the two current commercial hydrogen production technologies Steam Methane Reforming (SMR>95%), a thermochemical process, and Electrolysis, an electrochemical process.

FIG. 6 shows examples of the flows of two electrochemical devices: the upper reactor is an electrochemical reformer (ECR) that accepts methanol and water and heat and/or electricity and outputs hydrogen gas as the desired product and carbon dioxide as the by-product, assuming thermal stripping or operating at electrolyte saturation. The lower reactor is a carbon capture and re-use (CCR) device that accepts carbon dioxide, water, heat and electricity and outputs methanol (CH₃OH) as the desired product and oxygen as the by-product.

FIG. 7 shows a planar electrochemical reformer (ECR) cell that can be driven by electricity and/or heat with heat exchangers at each electrode for more precise and efficient thermal management.

FIG. 8 shows an electrochemical carbon capture and reuse (CCR) cell that can be driven by electricity and/or heat with heat exchangers at each electrode for more precise and efficient thermal management.

FIG. 9 shows a comparison of an ECR/CCR system to liquefied electrolytic hydrogen as a preferred method of bulk transport for renewable electricity.

FIG. 10 shows a comparison of an ECR/CCR system to ammonia as a liquid organic hydrogen carrier for electrolytic hydrogen from renewable energy sources.

FIG. 11 shows a cell with heat exchangers at each electrode for more precise and efficient thermal management.

FIG. 12 shows an integrated ECR/CCR module with heat exchangers at each electrode for more precise and efficient thermal management.

FIG. 13 shows an integrated ECR/Fuel Cell/CCR module with heat exchangers at each electrode for more precise and efficient thermal management.

### DETAILED DESCRIPTION OF THE INVENTION

The present invention describes the underlying technologies and methods of integrating them into novel configurations that will improve the thermal, carbon and economic efficiency of electrochemical cells, stacks, modules and systems. The key elements of the integrated systems are the ability to recover and reuse what is currently called “waste” heat (ΔH-enthalpy) and the more critical ability to recover and reuse the exothermic change in chemical potential (ΔG-Gibbs Free or Available Energy).

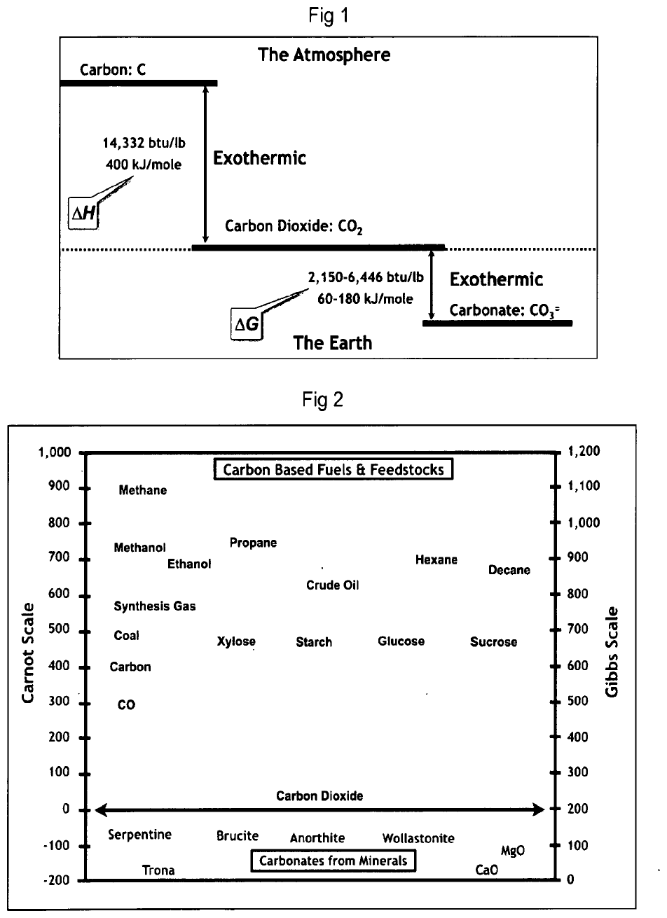

FIG. 1 shows both forms of energy recoverable from a carbon atom. The top step shows the 400 kJ per mole of ΔH available from the combustion of carbon to its final combustion by product, carbon dioxide. This is the generally accepted view of carbon utility and all current Carnot efficiency ratings are calculated by dividing the total recoverable energy out of a system (electricity, heat, etc.) by this figure. However, carbon dioxide is not the ground state of carbon, carbonate minerals have a lower energy state. The lower step shows the range of values of the chemical potential available, ΔG. This figure varies depending on what metal the carbon attaches itself to when its exothermically forms its carbonate mineral (a naturally occurring process called weathering). Carnot said that temperature is the ultimate limitation on efficiency but his rationale was incomplete since it excluded the effect of changes in chemical potential. This is the ultimate limit of efficiency, on which temperature depends.

FIG. 2 shows the energy content of a wide range of compounds with the ΔH Carnot scale on the left and the ΔG Gibbs scale on the right. Here CO₂ is at zero on the Carnot scale while it still has about 200 kJ available on the Gibbs scale. On the ΔG scale, even some minerals still have useful amounts of energy available (see sodium bicarbonate or Alka Seltzer).

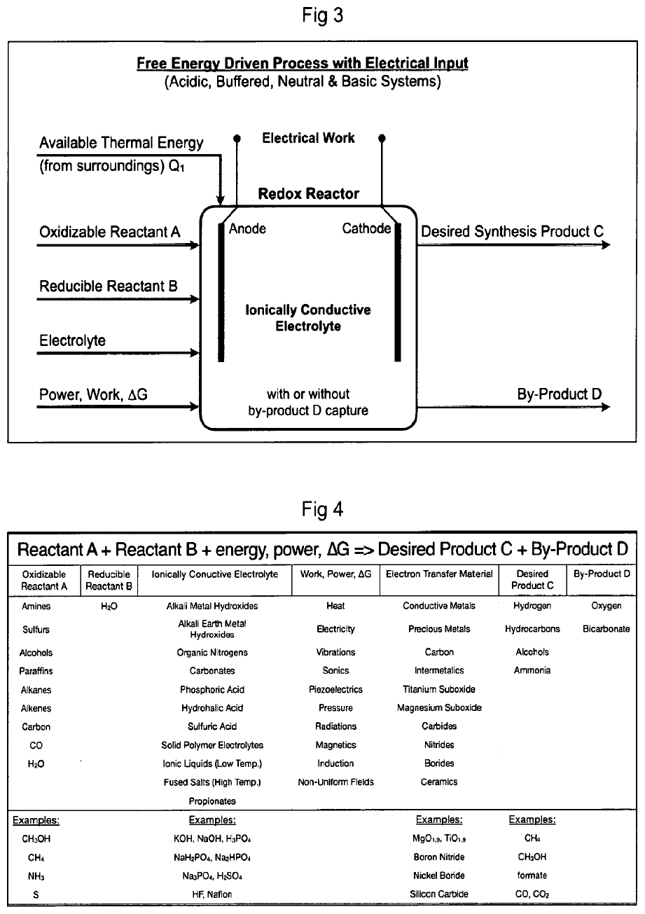

In order to benefit from this available energy a Free Energy Driven Process is needed. FIG. 3 shows a simplified schematic of such a process, where Oxidizable Reactant A and Reducible Reactant B are combined in a reactor with an Ionically Conductive Electrolyte, which can be acidic, neutral or basic, an electron transfer material, and some form of power or work is added (heat, electricity, or other form of ΔG). This will create Desired Synthesis Product C along with By-Product D, which can be captured in the solution or extracted from the reactor. FIG. 4 shows a matrix with a partial list of these reactants, electrolytes, forms of work, electron transfer materials, products and by-products. Desired systems would design the process to make by-product D salable as well as Product C. This would change the overall efficiency calculation from;

$$Efficiency \frac{Fuel Value Output}{Fuel Value Input}$$

$$to ,$$

$$Efficiency \frac{Product C Fuel Value + By - Product D Fuel Value}{Reactant A Value + Value of Work , Power \& Δ G}$$

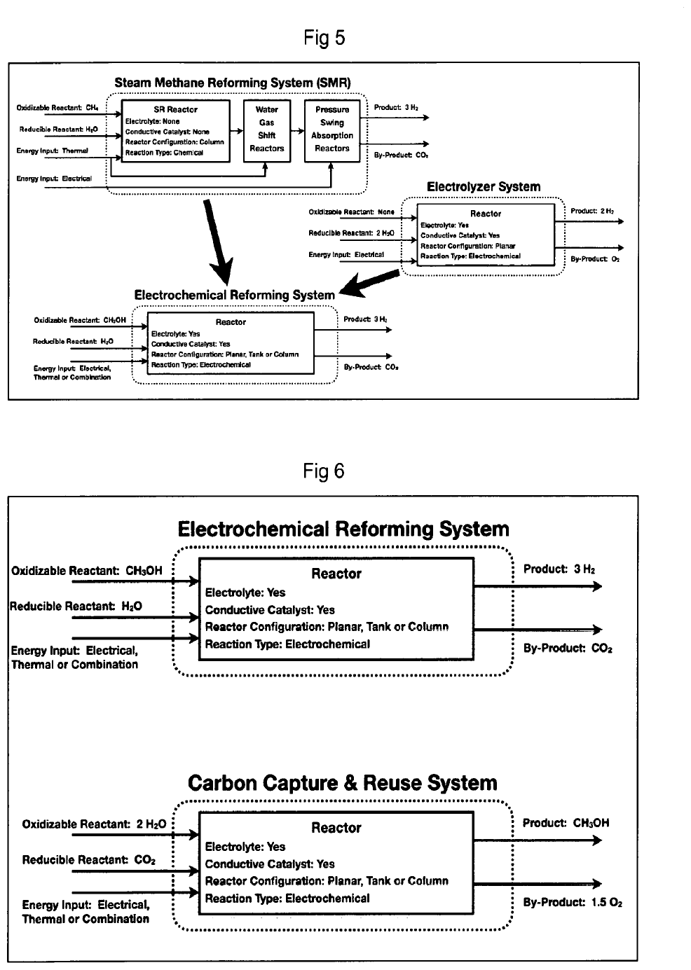

FIG. 5 shows an embodiment of this principle in a basic comparison of the Grimes liquid-phase ECR to the two commercially available methods of hydrogen generation used today, Steam Methane Reforming (SMR) and water electrolysis. The ECR combines the best features of each system thereby making up for the deficiencies in each. The SMR is missing an ionically conductive electrolyte and a conductive catalyst. The electrolyser is missing an oxidizable reactant. A comparison of the effect these omission is shown in the Table 2 below.

TABLE 2
Thermodynamic Comparison

| | | | | | | | | |
|---|---|---|---|---|---|---|---|---|
| | | | ΔG | ΔH | ΔG | ΔH | | |
| | | temp | kJ per | kJ per | kJ per | kJ per | cell | system |
| PROCESS | fuel | ° C. | mole fuel | mole fuel | mole H₂ | mole H₂ | voltage | efficiency |

CENTRALIZED NATURAL GAS

| | | | | | | | | |
|---|---|---|---|---|---|---|---|---|
| Steam Reforming | CH₄ | 850 | −38.77 | 40.40 | −9.69 | 10.10 | — | 65% |

CENTRALIZED & DISTRIBUTED

| | | | | | | | | |
|---|---|---|---|---|---|---|---|---|
| Electrolysis² | H₂O +e− | 75 | 54.76 | 67.94 | 54.76 | 67.94 | 1.95 | 65% |

DISTRIBUTED NATURAL GAS

| | | | | | | | | |
|---|---|---|---|---|---|---|---|---|
| Steam Reforming¹ | CH₄ | 800 | −35.31 | 42.00 | −8.80 | 10.50 | — | 65% |
| HT Reforming¹ | CH₄ | 700 | −27.86 | 45.17 | −6.97 | 11.29 | — | 55% |
| Autothermal Reforming¹ | CH₄ | 650 | −24.07 | 46.74 | −6.02 | 11.69 | — | 55% |
| Partial Oxidation¹ | CH₄ | 600 | −93.04 | −11.35 | −23.26 | −2.84 | — | 50% |
| Electrochemical Reforming (t)³ | CH₄ | 400 | −1.89 | 29.95 | −0.47 | 7.49 | — | 87% |
| Electrochecmial Reforming (e)² | CH₄ | 25 | 17.77 | 34.80 | 4.44 | 8.70 | 0.09 | 85% |

DISTRIBUTED METHANOL

| | | | | | | | | |
|---|---|---|---|---|---|---|---|---|
| Steam Reforming¹ | CH•OH | 280 | −18.03 | 25.95 | −6.01 | 8.65 | — | 65% |
| Electrochemical Reforming (t)³ | CH•OH | 200 | −17.71 | 2.87 | −5.90 | 0.96 | — | 87% |
| Electrochemical Reforming (e)² | CH•OH | 75 | −11.77 | 6.20 | −3.92 | 2.07 | 0.04 | 85% |

CENTRALIZED & DISTRIBUTED

| | | | | | | | | |
|---|---|---|---|---|---|---|---|---|
| Carbonate ECR (t)³ | C | 200 | −19.68 | 2.51 | −9.84 | 1.26 | — | 87% |
| Carbonate ECR (e)² | C | 50 | −13.51 | 1.38 | −6.75 | 0.69 | 0.04 | 78% |
| Bicarbonate ECR (t)³ | C | 200 | −5.62 | 8.51 | −2.81 | 4.25 | — | 87% |
| Bicarbonate ECR (e)² | C | 50 | −0.66 | 11.01 | −0.33 | 5.51 | 0.04 | 78% |

¹system effiency calculations include heat input, gas separation and compression
²electrolysis and electrically driven ECR system efficiencies and CC energy penalty are based on the use of renewable electricity sources
³system efficiency is calculated assuming the use of internal heat

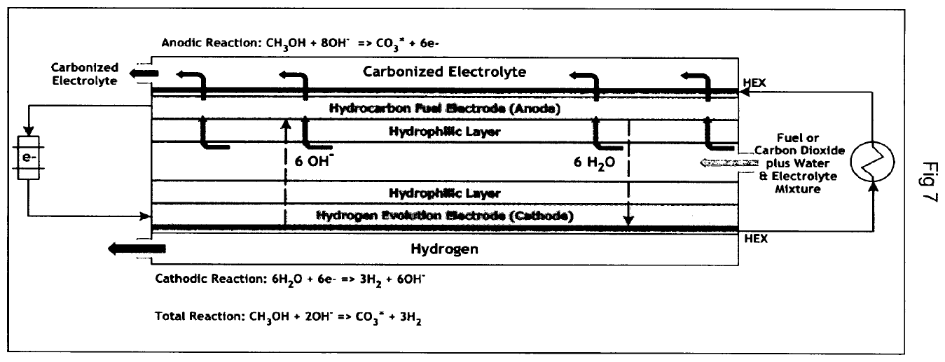

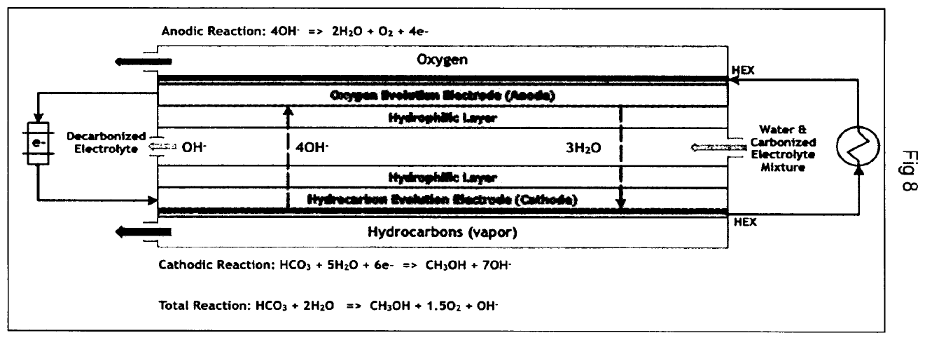

Here you can see that the lack of an oxidizable reactant increases the energy required to create a mole of hydrogen from water to 67.94 kJ. An SMR can deliver the same mole of hydrogen for an energy cost of 10.10 kJ but the temperature has risen from 75 to 800 C. An ECR can deliver the mole of hydrogen from methane thermally at half the temperature (400 C) and with a reduction in energy consumption to 7.49 kJ. If electricity is used to drive the ECR, the energy consumption will rise to 8.70 kJ but the temperature will drop to 25 C. However, since the process can be fed liquid as well as gaseous inputs, if methanol is used as the oxidizable reactant, the mole of hydrogen will cost only 0.96 kJ at a temperature of 200 C. This coupled with the fact that the ECR evolves hydrogen at a pressure slightly higher than the fuel/water/electrolyte mixture. The need for gas-phase hydrogen compression may be reduced or eliminated, offering significant commercial advantage. FIG. 6 shows the basic diagram of a methanol ECR with a thermal CO₂ stripper regenerating the carbonized electrolyte and a Carbon Capture & Reuse (CCR) cell that is capturing CO₂ and producing methanol and oxygen as the product and by-product.

FIG. 7 shows the details of flows and half-cell reactions for a preferred embodiment of this invention, a planar ECR cell that can be driven by electricity and/or heat. In this example methanol is the oxidizable reactant, water is the reducible reactant and hydroxide is the ionically conductive electrolyte. The net hydrogen production reaction is described in Equation 1 below.

CH₃OH+2OH=>3H₂+CO₃ (1)

These cells can have either a solid or liquid electrolytes and operate at a wide range of temperatures and pressures, depending on the input reactants and desired systems performance. Although carbonate is shown as the carbonized electrolyte output, depending on residence time and flow rates, this carbonate can continue to absorb more carbon until all carbonate is converted to bicarbonate, HCO₃. Either of these species can be i) immediately decarbonized ii) stored for later use, or, iii) transported to another location and regenerated at a later time, with the resultant outputs being returned to initiate the hydrogen generation cycle again.

FIG. 8 shows another embodiment of this invention, a planar CCR cell that is electrically driven to produce methanol and oxygen, as shown in Equation 2 below

HCO₃+2H₂O=>CH₃OH+1.5O₂+OH (2)

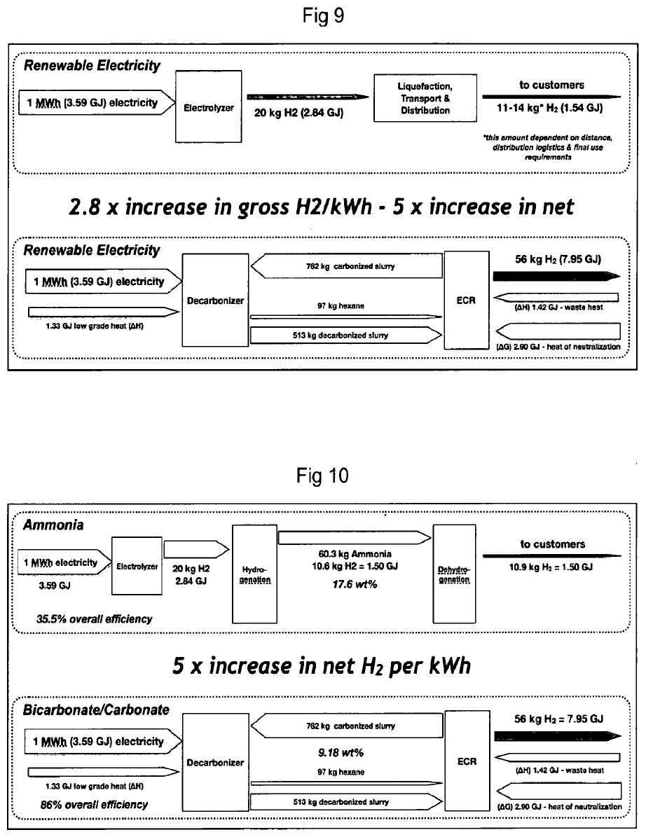

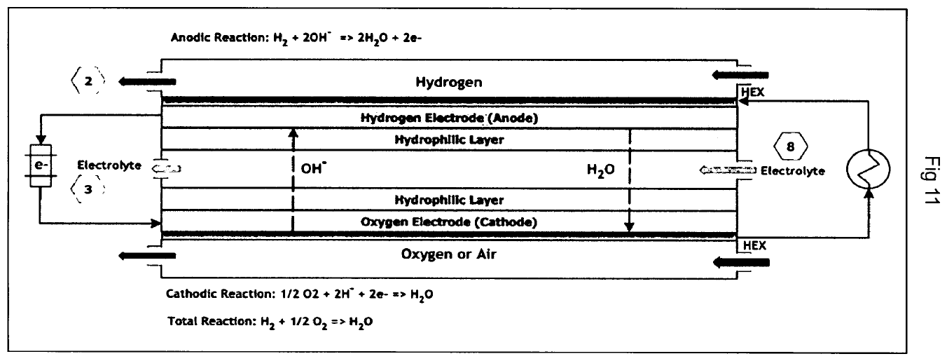

In the preferred embodiment of this invention, the methanol and oxygen produced would be used immediately to reduce or eliminate storage and transport costs. However, the methanol could be sold for export, stored for later use or it could be shipped, along with the decarbonized electrolyte, to another location, with the pair acting as a cost-effective alternative to liquefied hydrogen (see FIG. 9) as a method of moving hydrogen, or as a liquid organic hydrogen carrier, that would compete with such alternatives as ammonia or toluene (see FIG. 10).

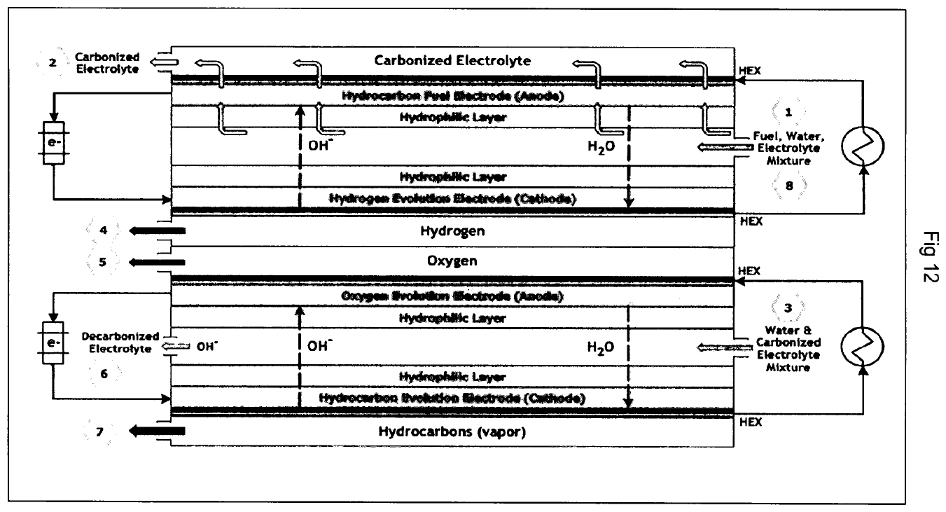

FIG. 11 shows an embodiment of this invention in a fuel cell, which produces electricity from hydrogen and oxygen.

H₂+0.5O₂=>H₂O+2e⁻ (3)

Another embodiment of this invention is the reverse reaction in a water electrolysis cell.

Cathodic Reduction:

2H₂O₍₁₎+2e⁻=>2H_{2(g)}+2OH_{(aq)} (4)

Anodic Oxidation:

OH_{(aq)}=>0.5O_{2(g)}+2H₂O₍₁₎+2e⁻ (5)

Overall Reaction:

2H₂O₍₁₎=>2H_{2(g)}+O_{2(g)} (6)

However, the ability to improve thermal management and efficiency, as well as reduce the need for mechanical gas compression, does not only apply to water electrolysis. There are a number of other opportunities for process improvement in areas such as the production of chlorine and metals such as lithium, sodium, potassium, magnesium calcium and aluminum.

Cathodic Reduction:

Al³⁺+3e⁻=>AL (7)

Anodic Oxidation:

O²⁻+C=>CO+2e⁻ (8)

### Overall Reaction:

Al₂O₃+3C=>2AL+3CO (9)

In current commercial practice, these cells are air cooled and most of the CO shifts to CO₂. Proper sealing and thermal management would offer an opportunity to reduce this energy consumption form the average 15.37 kWh per kg of Al produced closer to the theoretical ideal of 6.23 kWh. If these cells were only an inefficient as water electrolysis, the power consumption would be about 11.2 kWh/kg, a 26% reduction, and, all of the carbon emissions could be captured and reused.

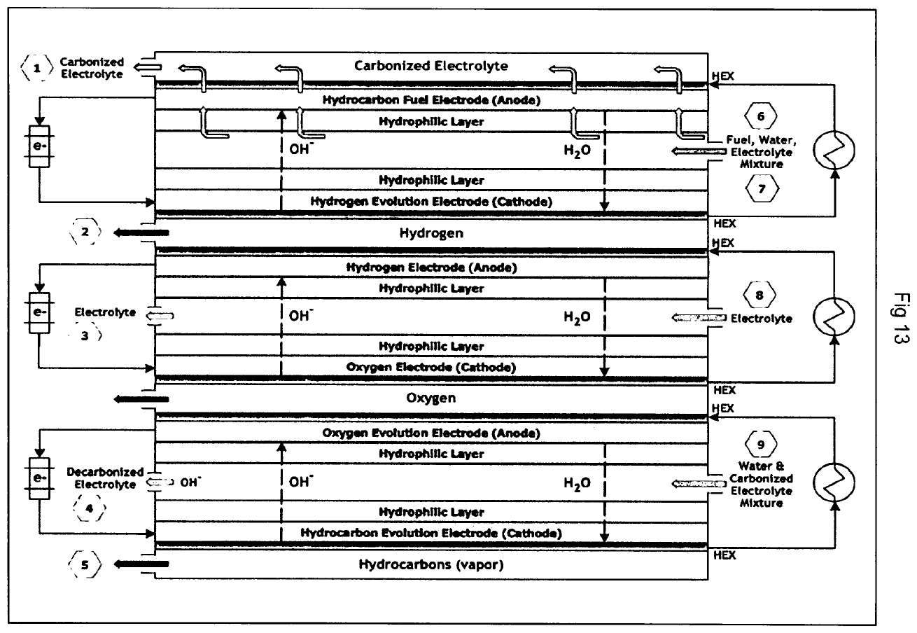

FIG. 12 shows an integrated ECR/CCR module operating in the following steps;
1. a fuel/water/electrolyte mixture enters the ECR cell
2. the fuel is oxidized and water is reduced producing carbonized electrolyte, which is recirculated to the input of the CCR cells at
3. while the product hydrogen evolving at the electrode vents at
4. for external use while the carbonized electrolyte input at 3 evolves oxygen at the CCR cell anode
5. which is vented for external use while the decarbonized electrolyte exiting at
6. also yields a hydrocarbon, or oxygenated hydrocarbon at the hydrocarbon evolution electrode,
7. which can be vented for export or recirculated to be mixed with the input fuel and water at
8.

Since these two cells are producing hydrogen and oxygen, an obvious preferred embodiment of this invention is shown in FIG. 13, which shows the integration of a fuel cell with the ECR and CCR cells arranged in such a manner as to have the hydrogen, from the ECR cell, and oxygen, from the CCR cell, evolve directly into the appropriate flow fields for the fuel cell input. In this manner, the fuel cell will never see any airborne impurities and normally these conditions will improve cell performance and increase longevity.

However, this is not the only embodiment of this invention. These cells can be separated into different sections of integrated stacks or separate stacks and modules integrated where appropriate in the overall system. This site-independent, time-independent, low-cost, high-performance modularity will enable factory built modules to provide high efficiency systems at any scale.

All documents, including patents, described herein are incorporated by reference herein, including any priority 45 documents and/or testing procedures. The principles, preferred embodiments, and modes of operation of the present invention have been described in the foregoing specification. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims

1. A planar electrochemical reformer (ECR) that is fed with a mixture of an oxidizable reactant (fuel), a reducible reactant (water) and a ionically conductive electrolyte (i.e. sodium hydroxide, potassium hydroxide, carbonate, buffer or acid) into a cell with a hydrogen evolution cathode and hydrocarbon fuel anode, the planar reactor being controlled by the addition of thermal or electrical input and/or output at each electrode.

2. The ECR according to claim 1 that uses carbon dioxide or carbon monoxide as its input fuel.

3-4. (canceled)

5. The ECR as in claim 1 that uses methanol or ethanol as its input fuel.

6. (canceled)

7. The ECR as according to claim 1 that uses natural gas or biogas as its input fuel.

8. (canceled)

9. The ECR according to claim 1 that uses carbon or a slurry made from pretreated coal as its input fuel.

10. (canceled)

11. The ECR according to claim 1 that uses Fischer-Tropsch Gases, Liquids or Waxes as its input fuel.

12. The ECR according to claim 1 that uses biochar as its input fuel.

13. The ECR according to claim 1 that uses char from hydrothermal carbonization of municipal solid waste, of medical waste or of biomass as its input fuel.

14-15. (canceled)

16. The ECR according to as in claim 1 that uses producer gas from gasification of biogas or coal or producer gas from plasma destruction of biomass, biogas, municipal solid waste, biosolids or coal as its input fuel.

17-18. (canceled)

19. A planar electrochemical CCR Decarbonizer that uses the input fuels according to claim 1, as the source of additional carbon fed into the initial electrolyte, the planar reactor being controlled by the addition of thermal or electrical input and/or output at each electrode.

20. The CCR Decarbonizer as according to claim 10 that uses carbon dioxide from an external capture subsystem as the source of additional carbon fed into the electrolyte.

21-30. (canceled)

31. An integrated Fuel Processing System comprised of an ECR according to claim 1 and a CCR Decarbonizer that uses the input fuels (the mixture) as the source of additional carbon fed into the initial electrolyte, the planar reactor being controlled by the addition of thermal or electrical input and/or output at each electrode, closely coupled for optimal thermal management and minimal external electrical and/or thermal input, that uses formate as its anode feed.

32-39. (canceled)
